(19) United States
(12) Patent Application Publication
(10) Pub. No.: US 2014/0249758 A1
(43) Pub. Date: Sep. 4, 2014

(54) DEVICE AND METHOD FOR RESIDUAL MOVEOUT PICKING OF GHOSTED SEISMIC DATA

(71) Applicant: CGG SERVICES SA, Massy Cedex (FR)

(72) Inventor: Robert SOUBARAS, Orsay (FR)

(73) Assignee: CGG SERVICES SA, Massy Cedex (FR)

(21) Appl. No.: 14/188,817

(22) Filed: Feb. 25, 2014

Related U.S. Application Data
(60) Provisional application No. 61/772,186, filed on Mar. 4, 2013.

(51) Int. Cl. G01V 1/34; G01V 1/28

(52) U.S. Cl. CPC G01V 1/34; G01V 1/28
USPC 702/16; 702/14

(57) ABSTRACT

A device, medium and method for processing ghosted seismic data associated with a subsurface of the earth. The method includes receiving the ghosted seismic data; receiving an initial velocity model; computing, in a processor, gathers G and mirror gathers M based on the ghosted seismic data and the initial velocity model; and calculating residual moveout curves r for each gather.

### BACKGROUND

1. Technical Field

Embodiments of the subject matter disclosed herein generally relate to methods and systems for processing ghosted seismic data and, more particularly, to mechanisms and techniques for residual moveout picking of ghosted seismic data.

2. Discussion of the Background

Seismic data acquisition and processing may be used to generate a profile (image) of geophysical structures under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where the oil and gas reservoirs are located.

The seismic processing includes many steps, among which, one is updating the velocity model. The velocity model describes the speed of the seismic waves in the subsurface. It is known that the speed of the seismic waves changes from layer to layer and knowing these changes help improving the accuracy of the final image of the subsurface. Traditionally, an initial velocity model is inaccurate and an iteration process may be used to update the model, based on the recorded seismic data. There are many approaches for updating the velocity model as will be recognized by those skilled in the art. One model computes, by a process called migration, a Common Image Gather (CIG) G(t,h) (or Common Time Gather or Common Depth Gather), where t is the migrated time and h is the offset between the source and the seismic receiver. Parameter t can be replaced by a depth z, and the offset h may be replaced by an angle θ without changing the nature of the described method. An exemplary CIG gather 100 is illustrated in FIG. 1 and shows events 102, 104 and 106. A muting function 108 is used to mute the traces to the right hand side of the figure. Note that the CIG gather is deghosted in this example, i.e., it does not include any ghost.

The migration process relies on the velocity model for migrating the events at their real occurrence. However, the velocity model is constructed based on the output of the migration process. Thus, there is a close connection between determining the velocity model and also generating the correct image of the surveyed subsurface. The velocity model is correct if the gathers exhibit only events that have a horizontal shape. Note that FIG. 1 shows events 104 and 106 having corresponding portions 104a and 106a, respectively, which are not flat. Thus, under certain circumstances (e.g., if portions 104a and 106a make up a significant part of events 104 and 106), the velocity model needs to be updated until the events become flat.

In order to update the initial velocity model, which again, can be achieved using various known algorithms, a residual moveout function r(τ) need to be calculated, where τ is a time as will be discussed later. The same residual moveout function r(τ) may be used for any velocity model updating process.

For calculating the residual moveout function, an initial step is to compute a complex gather (gather G(t,h) is a real quantity, not a complex quantity) by taking for each h the analytical signal of G(t,h). The analytical signal of G(t,h) is produced by, for example, a Fourier transform that transforms G(t,h) from the time domain t to frequency domain f. Other mathematical transforms may be applied, as for example, a radon transform. Then, the negative frequencies of the Fourier transform of G(t,h) are zeroed, and the positive frequency terms that are left are multiplied by number two. An inverse Fourier transform is applied to this result to end up with a complex gather G(t,h), which is a complex quantity.

Next, a semblance panel (see FIG. 2) is computed as discussed next based on a residual moveout curve tᵣ(τ,h). The residual moveout curve tᵣ associates a moveout time t, for a given residual moveout parameter r, with a time τ and offset h. FIG. 2 shows the moveout time t on the Y axis and the time τ on the X axis. As an example, a parabolic residual moveout curve is defined by:

$${t}_{τ} ( τ , h ) = τ + r \frac{{h}^{2}}{{h}_{max}^{2}} \qquad ( 1 )$$

where hₘₐₓ is the maximum offset of the gather. Other residual moveouts may be used.

Having the residual moveout curve, a gather with residual moveout gₙ(τ,r) is computed by considering the amplitude of the complex gather G(t,h) along moveout curves hₙ, with n being a natural number between 1 and N_{τ} and also being the offset value of the gathers. Number N_{τ} depends with τ because of the mute function 108 shown in FIG. 1. A generic gather with residual moveout is given by equation (2):

gₙ(τ,r)=G[tᵣ(τ,hₙ),hₙ] (2)

The semblance panel S of gₙ for each τ and r pair is now computed based on equation:

$$S ( τ , r ) = \frac{{\vert {\sum }_{n = 1}^{N} {g}_{n} [ τ , r ] \vert}^{2}}{N {\sum }_{n = 1}^{N} {\vert {g}_{n} [ τ , r ] \vert}^{2}} \qquad ( 3 )$$

and this is illustrated in FIG. 2. The range of r is given by interval [−Δt, Δt], where Δt is a user-defined parameter. For the semblance panel illustrated in FIG. 2, the value of Δt is 0.25 s.

Next, the residual moveout curve picking is performed on the semblance panel. The local maxima of the semblance panel are picked, as illustrated in FIG. 2, giving a certain number of pairs (τᵢ,rᵢ) 200. These picks can be interpolated to give a residual moveout curve r(τ) 202, also illustrated in FIG. 2. Various interpolation methods may be used for this step. For example, a linear interpolation has been used in FIG. 2 to determine the residual moveout curve r(τ).

The residual moveout function r(τ) picked in FIG. 2 can then be applied to the gather of FIG. 1 to obtain a new gather:

g(τ,h)=G[tᵣ(τ,h),h] (4)

which is illustrated in FIG. 3 and the events 300, 302 and 304 of the gather have now been flattened. The same process may be repeated for each gather. Regarding updating the velocity model, any known process may be applied to update the velocity model based on the flattened gathers given by equation (4).

The velocity model update process described above works well because the initial gather illustrated in FIG. 1 is a gather without ghost. This means that, as illustrated in FIG. 4, only up-going wavefields 400 (called primary events) that are reflected from a subsurface 401 and are recorded by a seismic receiver 402 are shown while down-going wavefields 404 (called ghost events) that are reflected from the water-surface 406 are eliminated. For an actual situation in which the seismic receivers are located on a streamer 410, the ghost event lags the primary event with a lag time determined by a depth D of the streamer or the respective seismic receiver relative to the water surface 406. The ghost has opposite polarity than the primary because the reflection coefficient of the water surface is substantially −1.

When the streamer is a horizontal streamer at a usual depth of 7 m, the ghost event does not perturb the picking in FIG. 2 significantly, because it is very close in time to the primary event. However, when the streamer is towed at high depth (e.g., more than 30 m), or when a variable-depth streamer is used (e.g., having a depth between 5 and 50 m for the front and back ends), the picking is perturbed by the ghost event as the ghost event lags considerably the primary event. This situation is illustrated in FIG. 5, in which a gather 500 corresponds to a variable-depth streamer with depths ranging from 5 to 50 m. The ghost events 502 are modeled together with the primary events 504. FIG. 5 also illustrates the mute function 506. If the semblance panel discussed-above (i.e., equation (3)) is calculated for this gather as illustrated in FIG. 6, the ghosts generate spurious (τᵢ,rᵢ) picks 600 in addition to the correct picks 602, which negatively affect the residual moveout function r(τ) 604. An incorrect residual moveout function results in an inaccurate velocity model and degraded processed seismic data, which ultimately affects the quality of the final image of the surveyed subsurface.

Thus, there is a need to have a process that considers the perturbation caused by the ghosts and remove or reduce spurious picks so that the residual moveout function is not degraded.

### SUMMARY OF THE INVENTION

According to an embodiment, there is a method for processing ghosted seismic data associated with a subsurface of the earth. The method includes receiving the ghosted seismic data; receiving an initial velocity model; computing, in a processor, gathers G and mirror gathers M based on the ghosted seismic data and the initial velocity model; and calculating residual moveout curves r for each gather.

According to another embodiment, there is a method for processing seismic data associated with a subsurface of the earth. The method includes receiving the seismic data; receiving an initial velocity model; computing, in a processor, gathers G and mirror gathers M based on the seismic data and the initial velocity model; transforming the gathers G to complex gathers g and the mirror gathers M to complex mirror gathers m; calculating cross-semblance panels C based on pairs of the complex gathers g and the complex mirror gathers m; and calculating residual moveout curves r for each complex gather.

According to yet another embodiment, there is a computing device for processing ghosted seismic data associated with a subsurface of the earth. The computing device includes an interface configured to receive the ghosted seismic data; and a processor connected to the interface. The processor is configured to receive an initial velocity model; compute gathers G and mirror gathers M based on the ghosted seismic data and the initial velocity model; and calculate residual moveout curves r for each gather.

### BRIEF DESCRIPTION OF THE DRAWINGS

For a more complete understanding of the present invention, reference is now made to the following descriptions taken in conjunction with the accompanying drawings, in which:

FIG. 1 is a graphical illustration of a deghosted gather;

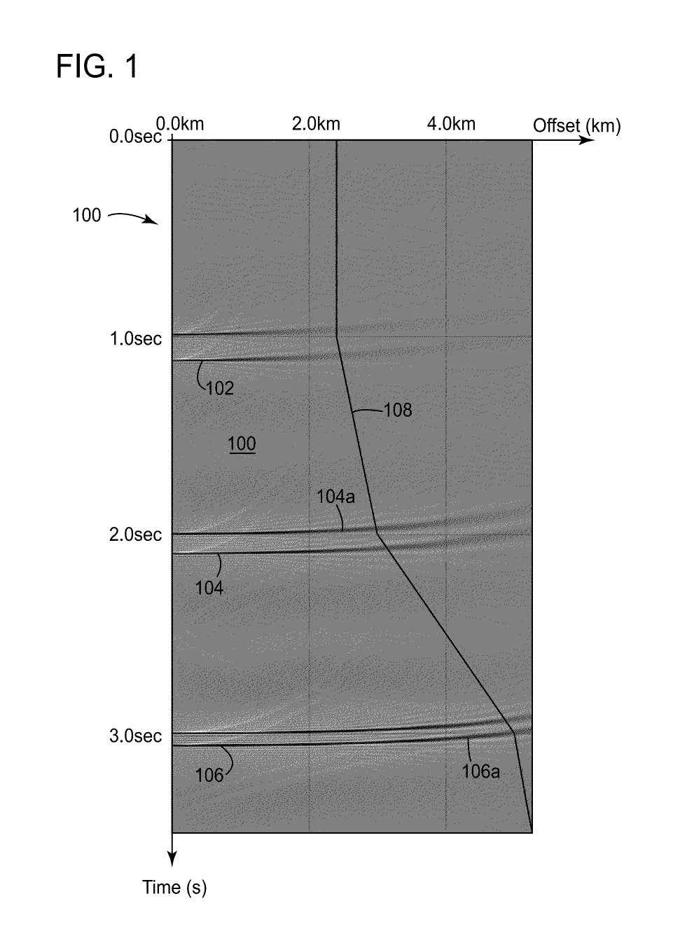

FIG. 2 is a graphical illustration of a semblance panel with picking;

FIG. 3 is a graphical illustration of a gather after picked residual moveout;

FIG. 4 is a schematic diagram of primary and ghost events for a marine seismic survey;

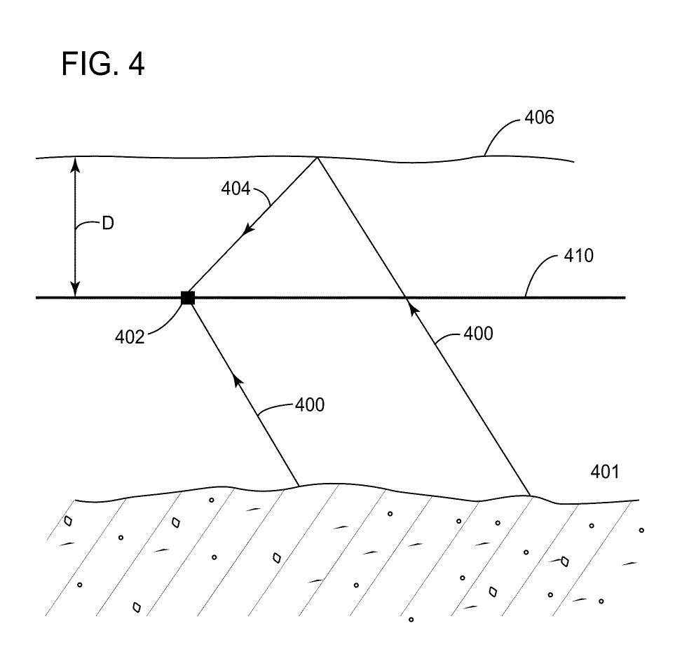

FIG. 5 is a graphical illustration of a gather with ghost data;

FIG. 6 is a graphical illustration of a semblance panel with picking negatively affected by ghost events;

FIG. 7 is a graphical illustration of a mirror gather;

FIG. 8 is a graphical illustration of a cross-semblance with picking;

FIG. 9 is a graphical illustration of a gather after picked residual moveout;

FIG. 10 is a graphical illustration of a mirror gather after picked residual moveout;

FIG. 11A is a flowchart of a method for updating a velocity model based on gathers and mirror gathers;

FIG. 11B is a flowchart of another method for updating a velocity model based on gathers and mirror gathers;

FIG. 12 is a schematic diagram of a marine seismic survey system; and

FIG. 13 is a schematic diagram of a computing device that is configured to update the velocity model.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a marine seismic system having a variable-depth streamer. However, the embodiments to be discussed next are not limited to a variable-depth streamer, but they may be applied to horizontal or slanted streamers being towed at a high depth (e.g., over 30 m from the water surface) or to ocean bottom cables or to a system that uses seismic nodes disposed at variable depths, where a seismic node may be an autonomous underwater vehicle.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a method for processing ghosted seismic data associated with a subsurface of the earth. The method includes receiving the ghosted seismic data; receiving an initial velocity model; computing, in a processor, gathers G and mirror gathers M based on the ghosted seismic data and the initial velocity model; and calculating residual moveout curves r for each gather.

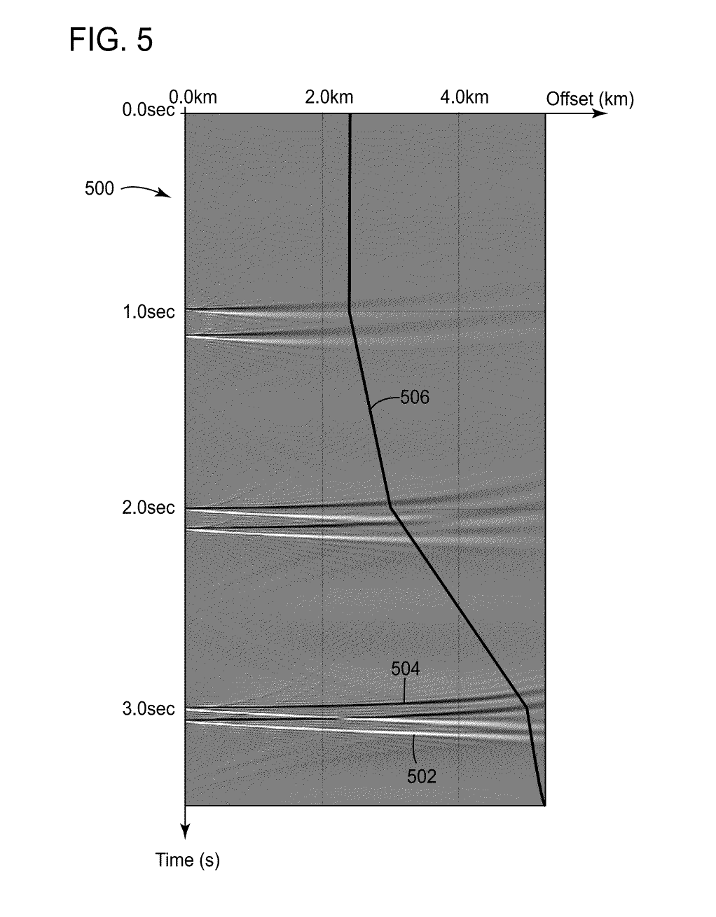

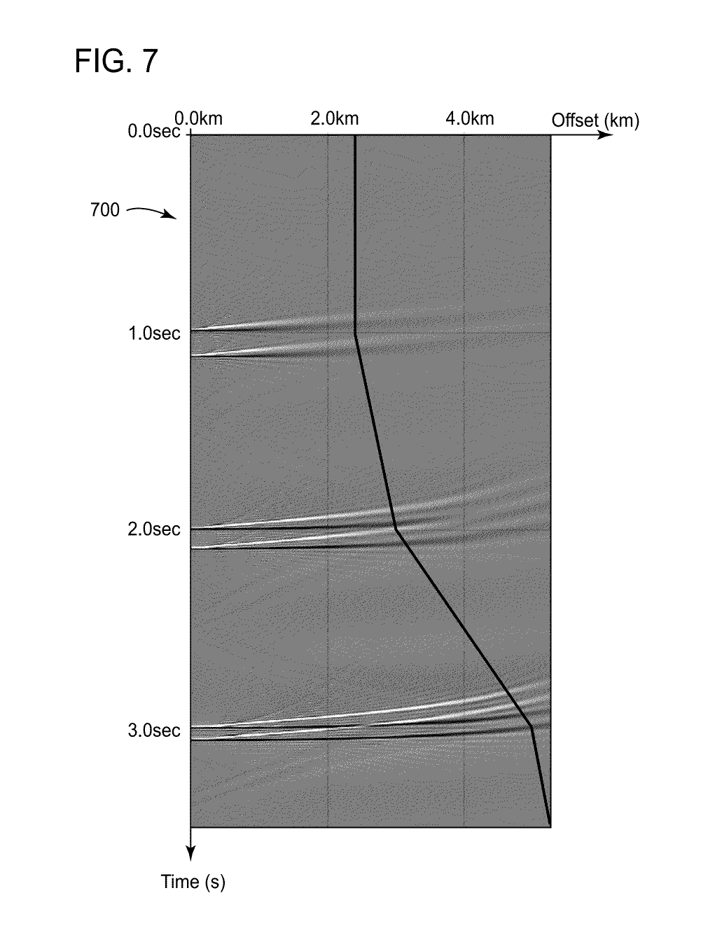

For simplicity, a method for residual moveout picking of ghosted seismic data is discussed based on seismic data acquired with a variable-depth streamer. To solve the problem generated by the perturbation caused by the ghosts, two inputs instead of one are used for residual moveout picking. In other words, with regard to the gather 500 (that includes both primary and ghost events) illustrated in FIG. 5, instead of using only this gather, an additional gather (the mirror gather) is used. The mirror gather 700 is illustrated in FIG. 7 and it also includes primary and ghost events.

Gathers 500 are computed by migrating the seismic measurements assuming they are made at their actual location (xₙ,yₙ,zₙ). This means that, when the velocity model is correct, the primary events are horizontal in the gather. Gathers 700 are computed using a mirror migration process, which is performed by assuming the seismic measurements are made at the mirror location (xₙ,yₙ,−zₙ), and with a polarity reversal. This means that, when the velocity model is correct, the ghosts events are horizontal, because the mirror migration focuses the ghosts events instead of the primary events. While the mirror migration process has been previously described (see for example, U.S. Pat. Nos. 8,451,682 and 8,456,695, the entire contents of which are incorporated herein by reference), there is no description of a process involving the use of a mirror gather in conjunction with a gather for obtaining a residual moveout curve. Such a novel process is now described.

An advantage of one or more of the embodiments to be discussed next, is that when the velocity model is incorrect, the primary events have given residual moveout (RMO) curves on the migrated gathers, and the ghost events have the same RMO on the mirror migrated gathers. The migrated gathers are perturbed by the ghost events, which arrive after the primary events, while the mirror gathers are perturbed by the primary events, which arrive before the ghost events.

When the velocity model is incorrect, it is difficult to distinguish on the migrated gather the primary events from the ghost events because none of them are horizontal. Thus, the picking of the correct RMO function is difficult because it is easy to misconstrue as horizontal some primary events and some ghost events although they are not horizontal. However, by using both the migrated gathers and the mirror migrated gathers, the events that need to be made horizontal are those present on both types of gathers and this cannot be achieved by using the conventional methods that use a single type of gather.

There are several ways to make horizontal the common part of the migrated gathers and the mirror migrated gathers. For example, it is possible to introduce a novel cross-semblance quantity and maximize the cross-semblance of the migrated gathers G(t,h) and mirror-migrated gathers M(t,h). The migrated gathers G(t,h) and mirror-migrated gathers M(t,h) are made complex (for example, as discussed in the background section) and then gathers with residual moveout gₙ(τ,r)=G[tᵣ(τ,hₙ),hₙ] and mₙ(τ,r)=M[tᵣ(τ,hₙ),hₙ] are calculated. The residual moveout tᵣ(τ,h) used in the gathers with residual moveout may be the one used in equation (1) or another one. Instead of using the conventional semblance S as defined in equation (3), a novel cross-semblance C(τ,r) is introduced to calculate a cross-semblance panel based on both gathers with residual moveout gₙ and mₙ. Note that the semblance defined by equation (3) is not capable to simultaneously handle migrated gathers and mirror-migrated gathers while the cross-semblance C(τ,r) can do. One example of a cross-semblance is given by equation (5):

$$C ( τ , r ) = \frac{Re ( \overline{{\sum }_{n = 1}^{N} {g}_{n} ( τ , r )} {\sum }_{n = 1}^{N} {m}_{n} ( τ , r ) )}{{( N {\sum }_{n = 1}^{N} {\vert {g}_{n} ( τ , r ) \vert}^{2} )}^{1 / 2} {( N {\sum }_{n = 1}^{N} {\vert {m}_{n} ( τ , r ) \vert}^{2} )}^{1 / 2}} . \qquad ( 5 )$$

Other cross-semblance formulae may be imagined by those skilled in the art.

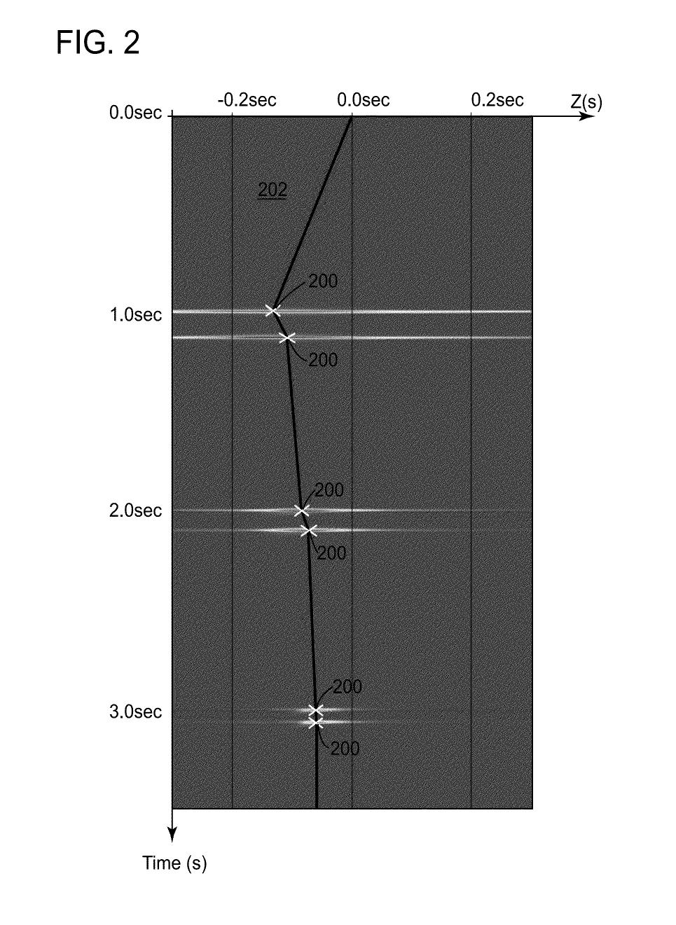

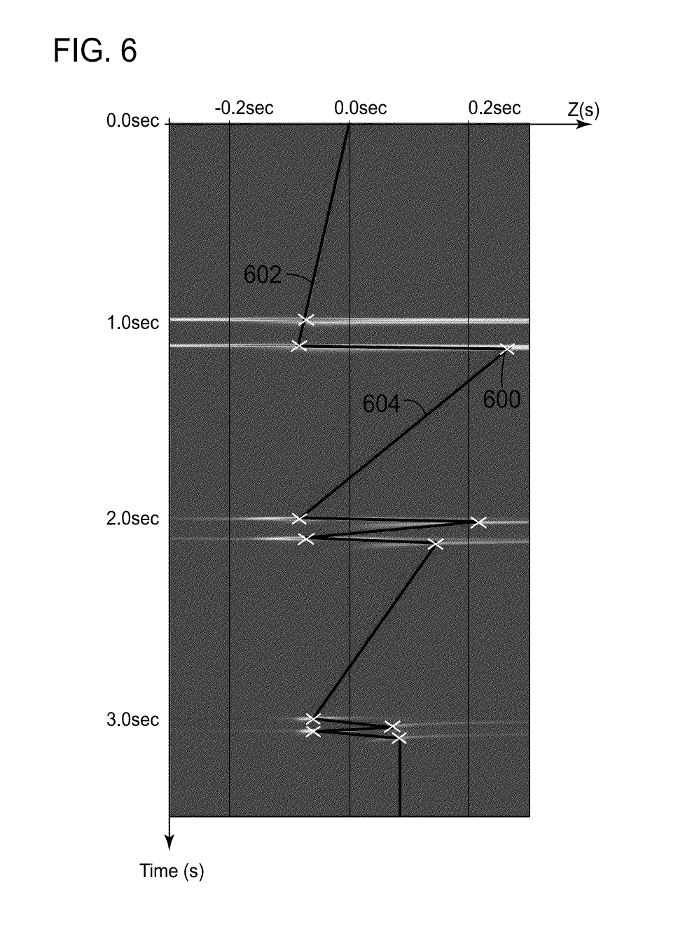

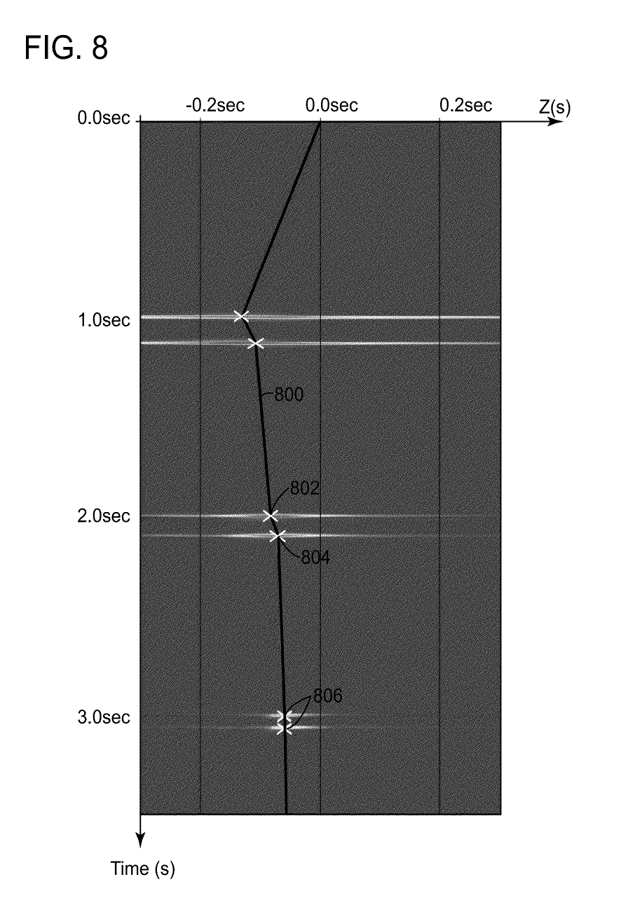

FIG. 8 illustrates the cross-semblance panel for the migrated gather of FIG. 5 and the mirror migrated gather of FIG. 7 and also picks 802, 804 and 806 and the residual moveout curve 800. The residual moveout curve 800 is calculated for each gather and these curves are then used to update the velocity model. Comparing FIG. 8 with FIG. 6, it is noted the lack of spurious picks in FIG. 8 due to the novel cross-semblance of the migrated gathers and migrated mirror gathers. Further, it is noted that the picks shown in FIG. 8 are identical to the picks from FIG. 2, which corresponds to the situation where there are no ghost events in the data. This indicates that the cross-semblance is capable of correctly generating the picks although ghost events are present.

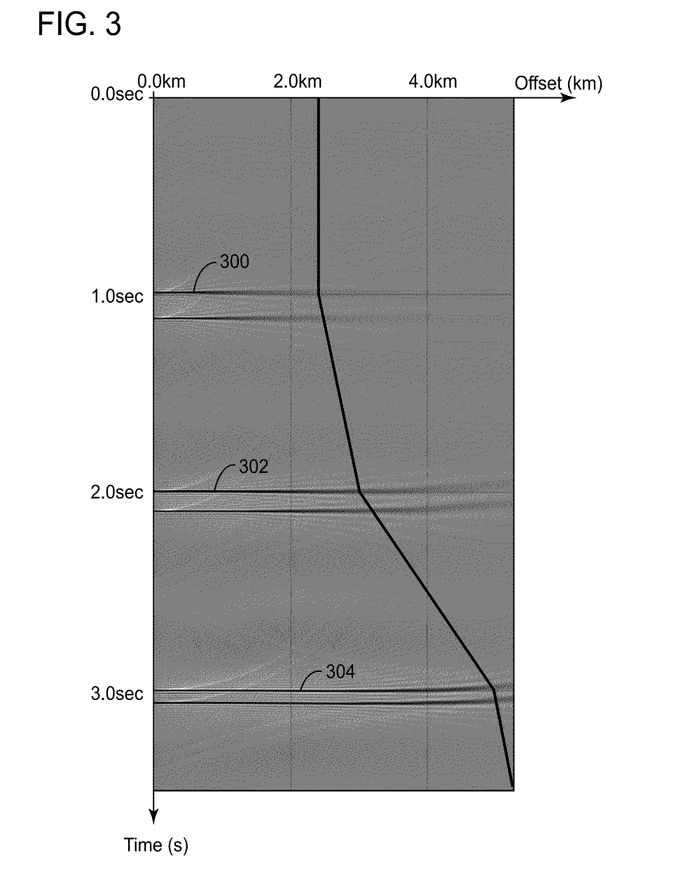

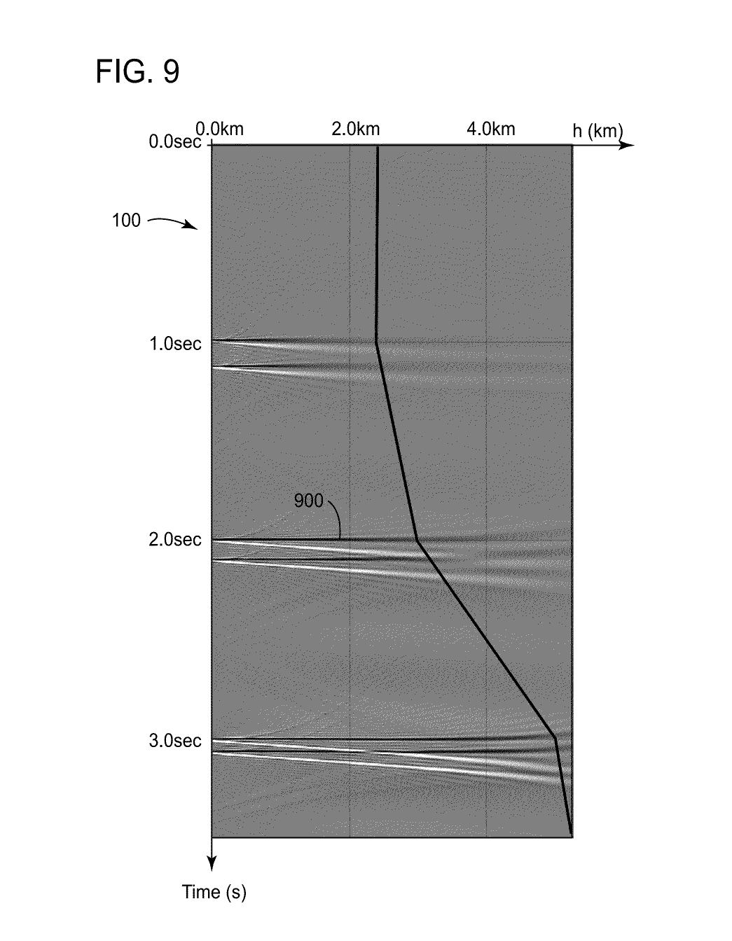

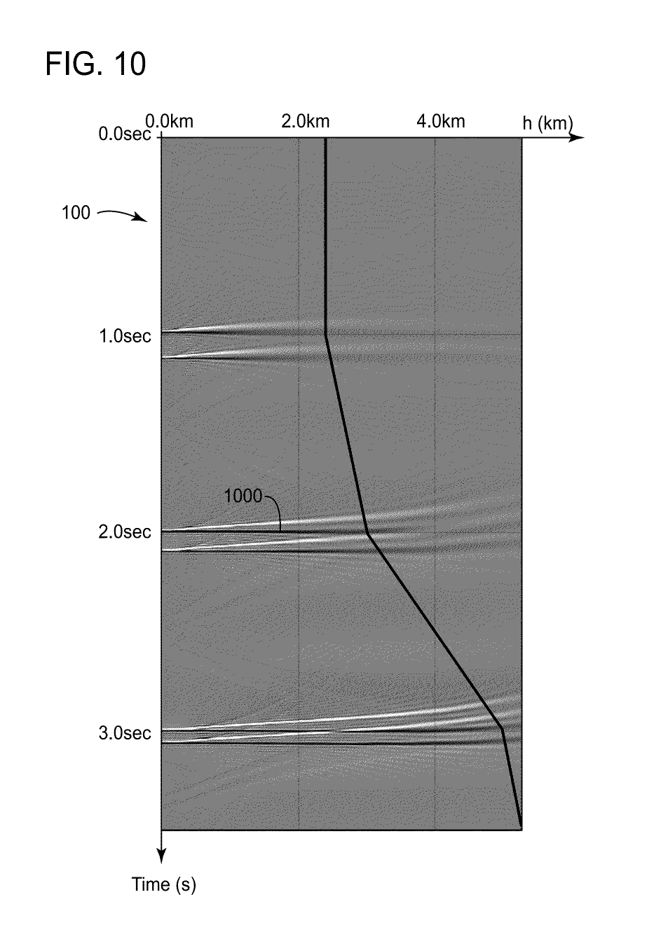

FIGS. 9 and 10 illustrate the gather and mirror gathers after applying the picked RMO curve 800 of FIG. 8. The flatness of the primary events 900 and 1000 on both gathers is as good as those shown in FIG. 3. This indicates that the cross-semblance produces residual moveout picking without being perturbed by the ghost events.

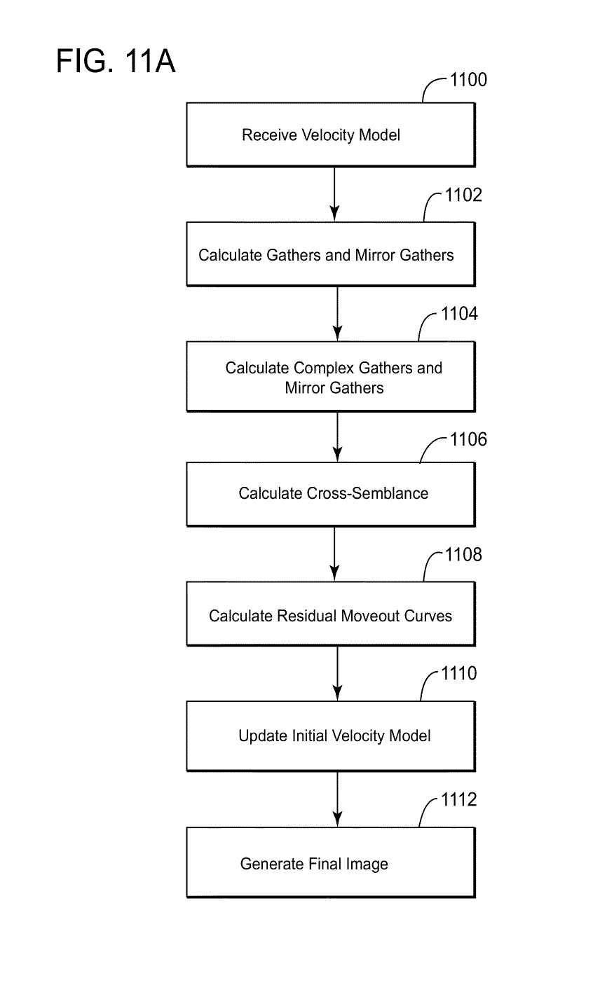

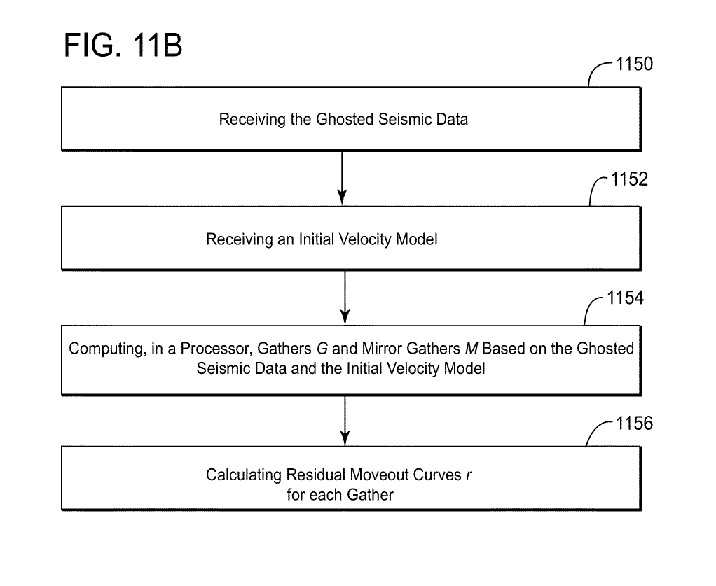

Based on the above-described embodiments, a method for updating a velocity model is now presented with regard to FIG. 11A. In step 1100, a velocity model is considered. The velocity model may be calculated with another method based on the collected seismic data, or it may be determined based on log data, or it may be selected from an existing library of velocity models, or it may be estimated based on theoretical considerations. Based on this initial velocity model, gathers and mirror gathers G and M are computed in step 1102. The gathers may be CIG gathers or other known gathers. Then, in step 1104, complex analytical gathers and mirror gathers gₙ and mₙ are calculated based on gathers and mirror gathers G and M. A cross-semblance C(τ,r) is calculated in step 1106, based on both the complex analytical gathers and mirror gathers gₙ and mₙ. The cross-semblance may be given by equation (5) or another equation may be used as long as the new equation takes into consideration both types of gathers. In step 1108, residual moveout curves r(τ) are calculated for each gather and in step 1110 the initial velocity model is updated based on the calculate residual moveout curves r(τ). This step may also include updating each gather based on the calculated residual moveout curves. The updated velocity model may be used, in step 1112, together with the gathers to calculate a final image of the surveyed subsurface.

Another method for processing ghosted seismic data associated with a subsurface of the earth is illustrated in FIG. 11B. The method includes a step 1150 of receiving the ghosted seismic data; a step 1152 of receiving an initial velocity model; a step 1154 of computing, in a processor, gathers G and mirror gathers M based on the ghosted seismic data and the initial velocity model; and a step 1156 of calculating residual moveout curves r for each gather. Those skilled in the art would recognize that various modifications of the flowcharts illustrated in FIGS. 11A-B may be implemented and still be capable of updating the velocity model.

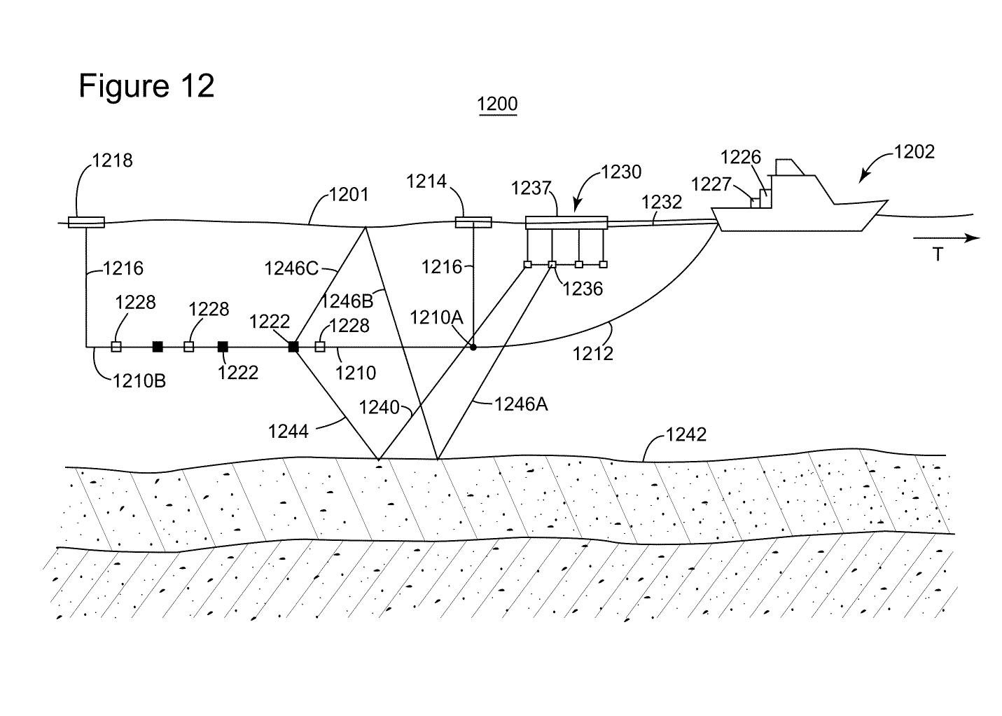

The above processes may be implemented in a land survey (in which the seismic receivers are buried at different depths) or in a marine survey that uses variable-depth streamers or slanted streamers or ocean bottom cables, or seismic nodes that float at different depths. If a marine survey system that uses streamers is employed, it typically has a setup as illustrated in FIG. 12, which shows a system 1200 having a vessel 1202 that tows one or more streamers 1210 (only one is shown in the figure for simplicity) and a seismic source 1230. Note that seismic streamer 1210 may be horizontal as illustrated in the figure, but also slanted to the water surface 1204 or it may have a variable-depth profile. Streamer 1210 is attached through a lead-in cable (or other cables) 1212 to vessel 1202, while source 1230 is attached through an umbilical 1232 to the vessel. A head float 1214, which floats at the water surface 1204, is connected through a cable 1216 to the head 1210A of streamer 1210, while a tail buoy 1218 is connected through a similar cable 1216 to the tail 1210B of streamer 1210. Head float 1214 and tail buoy 1218 maintain the streamer's depth among other things.

Streamer 1210 includes plural sensors 1222 (only a few are illustrated in FIG. 12 for simplicity) for collecting seismic data. Position control devices 1228 (also known as birds) may be distributed along the streamer for controlling a vertical and/or horizontal position of the streamer.

Source 1230 may include plural source elements 1236 that are connected to a float 1237 to travel at desired depths below the water surface 1204. Source elements may be distributed at the same depth or different depths to obtain a multi-level source array. During operation, vessel 1202 follows a predetermined path T while source elements (usually air guns) 1236 emit seismic waves 1240. These waves bounce off the ocean bottom 1242 and other layer interfaces below the ocean bottom 1242 and propagate as reflected/refracted waves 1244 that are recorded (as primaries) by sensors 1222. However, each primary has an associated ghost 1246c, which corresponds to another wave 1246a generated by source 1230, reflected as wave 1246b from the ocean bottom 1242, and then further reflected from the water surface 1204.

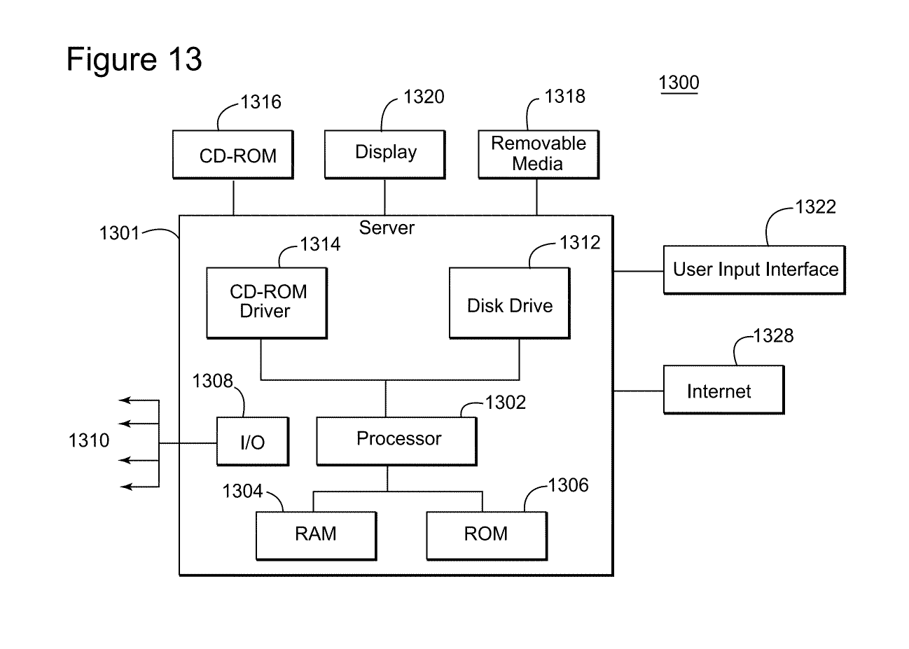

The above methods and others may be implemented in a computing system specifically configured to calculate the subsurface image. An example of a representative computing system capable of carrying out operations in accordance with the exemplary embodiments is illustrated in FIG. 13. Hardware, firmware, software or a combination thereof may be used to perform the various steps and operations described herein.

The exemplary computing system 1300 suitable for performing the activities described in the exemplary embodiments may include a server 1301. Such a server 1301 may include a central processor (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Processor 1302 may communicate with other internal and external components through input/output (I/O) circuitry 1308 and bussing 1310, to provide control signals and the like. Processor 1302 carries out a variety of functions as are known in the art, as dictated by software and/or firmware instructions.

The server 1301 may also include one or more data storage devices, including a disk drive 1312, CD-ROM drives 1314, and other hardware capable of reading and/or storing information such as DVD, etc. In one embodiment, software for carrying out the above-discussed steps may be stored and distributed on a CD- or DVD-ROM 1316, removable memory device 1318 or other form of media capable of portably storing information. These storage media may be inserted into, and read by, devices such as the CD-ROM drive 1314, the disk drive 1312, etc. The server 1301 may be coupled to a display 1320, which may be any type of known display or presentation screen, such as LCD, LED displays, plasma displays, cathode ray tubes (CRT), etc. A user input interface 1322 is provided, including one or more user interface mechanisms such as a mouse, keyboard, microphone, touchpad, touch screen, voice-recognition system, etc.

The server 1301 may be coupled to other computing devices, such as landline and/or wireless terminals, via a network. The server may be part of a larger network configuration as in a global area network (GAN) such as the Internet 1328, which allows ultimate connection to various landline and/or mobile client devices. The computing device may be implemented on a vehicle that performs a land seismic survey.

The disclosed exemplary embodiments provide a system and a method for using migrated gathers and migrated mirror gathers. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for processing ghosted seismic data associated with a subsurface of the earth, the method comprising:
receiving the ghosted seismic data;
receiving an initial velocity model;
computing, in a processor, gathers G and mirror gathers M based on the ghosted seismic data and the initial velocity model; and
calculating residual moveout curves r for each gather.

2. The method of claim 1, further comprising:
calculating complex analytical gathers g and complex analytical mirror gathers m based on the gathers G and mirror gathers M, respectively.

3. The method of claim 2, further comprising:
calculating cross-semblance panels C for pairs of complex analytical gathers g and mirror gathers m.

4. The method of claim 3, wherein the residual moveout curves r are calculated by picking local maxima from the cross-semblance panels C.

5. The method of claim 3, wherein the cross-semblance panel C is given by
$$C ( τ , r ) = \frac{Re ( \overline{{\sum }_{n = 1}^{N} {g}_{n} ( τ , r )} {\sum }_{n = 1}^{N} {m}_{n} ( τ , r ) )}{{( N {\sum }_{n = 1}^{N} {\vert {g}_{n} ( τ , r ) \vert}^{2} )}^{1 / 2} {( N {\sum }_{n = 1}^{N} {\vert {m}_{n} ( τ , r ) \vert}^{2} )}^{1 / 2}} ,$$
where τ is a time, r is a residual moveout parameter, N is a maximum offset value for the gathers, gₙ is a gather with residual moveout, mₙ is a mirror gather with residual moveut, and n is an index that take any value between 1 and N.

6. The method of claim 1, further comprising:
updating the initial velocity model based on the residual moveout curves r.

7. The method of claim 6, further comprising:
generating a final image of the surveyed subsurface based on the updated velocity model and the ghosted seismic data.

8. The method of claim 1, further comprising:
acquiring the ghosted seismic data with a variable-depth profile streamer.

9. The method of claim 1, further comprising:
acquiring the ghosted seismic data with a streamer having seismic receivers situated at more than 30 m below a water surface.

10. The method of claim 1, wherein the ghosted seismic data includes ghost events that are separated from primary events.

11. The method of claim 1, wherein primary events in the ghosted seismic data have given residual moveout curves in the migrated gathers and ghost events in the ghosted seismic data have the same given residual moveout curves in the mirror migrated gathers.

12. A method for processing seismic data associated with a subsurface of the earth, the method comprising:
receiving the seismic data;
receiving an initial velocity model;
computing, in a processor, gathers G and mirror gathers M based on the seismic data and the initial velocity model;
transforming the gathers G to complex gathers g and the mirror gathers M to complex mirror gathers m;
calculating cross-semblance panels C based on pairs of the complex gathers g and the complex mirror gathers m; and
calculating residual moveout curves r for each complex gather.

13. The method of claim 12, wherein the residual moveout curves r are calculated by picking local maxima from the cross-semblance panels C.

14. The method of claim 12, wherein the cross-semblance panel C is given by
$$C ( τ , r ) = \frac{Re ( \overline{{\sum }_{n = 1}^{N} {g}_{n} ( τ , r )} {\sum }_{n = 1}^{N} {m}_{n} ( τ , r ) )}{{( N {\sum }_{n = 1}^{N} {\vert {g}_{n} ( τ , r ) \vert}^{2} )}^{1 / 2} {( N {\sum }_{n = 1}^{N} {\vert {m}_{n} ( τ , r ) \vert}^{2} )}^{1 / 2}} ,$$
where τ is a time, r is a residual moveout parameter, N is a maximum offset value for the gathers, gₙ is a gather with residual moveout, mₙ is a mirror gather with residual moveut, and n is an index that take any value between 1 and N.

15. The method of claim 12, further comprising:
updating the initial velocity model based on the residual moveout curves r.

16. The method of claim 15, further comprising:
generating a final image of the surveyed subsurface based on the updated velocity model.

17. The method of claim 12, further comprising:
acquiring the seismic data with a variable-depth profile streamer or with a streamer having seismic receivers situated at more than 30 m below the water surface.

18. A computing device for processing ghosted seismic data associated with a subsurface of the earth, the computing device comprising:
an interface configured to receive the ghosted seismic data; and
a processor connected to the interface and configured to,
receive an initial velocity model;
compute gathers G and mirror gathers M based on the ghosted seismic data and the initial velocity model; and
calculate residual moveout curves r for each gather.

19. The computing device of claim 18, wherein the processor is further configured to:
calculate complex analytical gathers g and complex analytical mirror gathers m based on the gathers G and mirror gathers M, respectively.

20. The computing device of claim 19, wherein the processor is further configured to:
calculate cross-semblance panels C for pairs of complex analytical gathers g and mirror gathers m.
